(19) United States
(12) Patent Application Publication
(10) Pub. No.: US 2025/0384176 A1
(43) Pub. Date: Dec. 18, 2025

(54) METHODS FOR STABILITY ANALYSIS OF REINFORCED SOIL SLOPES CONSIDERING UNIFORMLY DISTRIBUTED FRICTIONAL RESISTANCES BETWEEN SOIL AND REINFORCEMENT MATERIALS

(71) Applicants: TIANJIN PORT ENGINEERING INSTITUTE CO., LTD. OF CCCC FIRST HARBOR ENGINEERING CO., LTD., Tianjin (CN); CCCC FIRST HARBOR ENGINEERING CO., LTD., Tianjin (CN); TIANJIN PORT ENGINEERING QUALITY TESTING CENTER CO., LTD., Tianjin (CN)

(72) Inventors: Yonghua CAO, Tianjin (CN); Wei PAN, Tianjin (CN); Changxi YUE, Tianjin (CN); Changyi YU, Tianjin (CN)

(73) Assignees: TIANJIN PORT ENGINEERING INSTITUTE CO., LTD. OF CCCC FIRST HARBOR ENGINEERING CO., LTD., Tianjin (CN); CCCC FIRST HARBOR ENGINEERING CO., LTD., Tianjin (CN); TIANJIN PORT ENGINEERING QUALITY TESTING CENTER CO., LTD., Tianjin (CN)

(21) Appl. No.: 19/317,157

(22) Filed: Sep. 3, 2025

Related U.S. Application Data
(63) Continuation-in-part of application No. PCT/CN2024/106691, filed on Jul. 22, 2024.

(30) Foreign Application Priority Data
Apr. 24, 2024 (CN) 202410494438.3

(51) Int. Cl. G06F 30/13; G06F 119/02; G06F 119/14

(52) U.S. Cl. CPC G06F 30/13; G06F 2119/02; G06F 2119/14

(57) ABSTRACT

A method for stability analysis of a reinforced soil slope is provided. The method includes: establishing a cross-sectional model for a target reinforced soil slope; establishing a force equilibrium equation and a moment equilibrium equation for the target reinforced soil slope; establishing a moment equation for any point within the cross-section of the target reinforced soil slope based on the moment equilibrium equation; establishing a soil yield function considering a stability function; establishing a relationship between the force equilibrium equation, the moment equation, and the soil yield function; determining the resisting moment of the target reinforced soil slope; determining the sliding moment of the target reinforced soil slope; establishing a stability factor calculation model for the target reinforced soil slope based on the resisting moment and the sliding moment; calculating the stability factor according to the stability factor calculation model for the target reinforced soil slope.

### CROSS-REFERENCE TO RELATED APPLICATIONS

This application is a continuation-in-part of International Patent Application No. PCT/CN2024/106691, filed on Jul. 22, 2024, which claims priority to Chinese Patent Application No. 202410494438.3, filed on Apr. 24, 2024, the entire contents of which are incorporated herein by reference.

### TECHNICAL FIELD

The present disclosure relates to the technical field of reinforced soil slopes, and in particular, to a method for stability analysis of a reinforced soil slope considering a uniformly distributed frictional resistance between soil and a reinforcement material.

### BACKGROUND

Generally, after reinforcing a soil slope, the size of the cross-section of the soil slope can be effectively reduced and the stability of the soil slope can be improved, which is of significant economic benefit. Currently, the theoretical study on the soil reinforcement mechanism is relatively underdeveloped, and methods for stability analysis of a soil slope considering a reinforcement layer are still inadequate. The calculation results for stability analysis of the soil slope fail to adequately reflect the effect of the soil reinforcement mechanism, and the calculation results are overly conservative, deviating significantly from actual engineering conditions, which may lead to a waste of resources.

Therefore, it is desirable to provide a method for stability analysis of a reinforced soil slope considering a uniformly distributed frictional resistance between soil and a reinforcement material to enhance the accuracy of the determination of a stability factor of the soil slope and reduce the waste of resources.

### SUMMARY

One or more embodiments of the present disclosure provide a method for stability analysis of a reinforced soil slope considering a uniformly distributed frictional resistance between soil and a reinforcement material, comprising: establishing a cross-sectional model for a target reinforced soil slope to be analyzed, including establishing computational relationships for the target reinforced soil slope including: a vertical load of a soil slope surface, a horizontal load of the soil slope surface, a unit weight per unit width of soil, a horizontal force of a slope body, a vertical shear force of the slope body, and a soil moment, wherein
the vertical load of the soil slope surface: p_{z}=(σ+τh′)Γₛ,
the horizontal load of the soil slope surface: pₓ=(τ−σh′)Γₛ,
the unit weight per unit width of soil:

$${w}_{γ} = {\int }_{{h}_{s}}^{h} γ d z ,$$

the horizontal force of the slope body:

$$E = {\int }_{{h}_{s}}^{h} {σ}_{x} d z ,$$

the vertical shear force of the slope body:

$$T = {\int }_{{h}_{s}}^{h} {τ}_{x z} d z ,$$

and

$$M = {\int }_{{h}_{s}}^{h} {σ}_{x} ( h - z ) d z ,$$

the soil moment:

where p_{z} denotes the vertical load of the soil slope surface, pₓ denotes the horizontal load of the soil slope surface, h denotes a sliding surface, h′ denotes a slope of the sliding surface, hₛ denotes the soil slope surface, σ denotes a normal stress on the sliding surface, t denotes a tangential shear stress on the sliding surface, w_{γ} denotes the unit weight per unit width of soil, γ denotes a unit weight of soil, E denotes the horizontal force of the slope body, T denotes the vertical shear force of the slope body, σₓ denotes a stress in an x-direction of the slope body, τ_{xz} denotes a vertical shear stress of the slope body, M denotes the soil moment, xz denotes a cross-section of the target reinforced soil slope, x denotes a horizontal direction of the cross-section of the target reinforced soil slope, z denotes a vertical direction of the cross-section of the target reinforced soil slope;

establishing a force equilibrium equation and a moment equilibrium equation for the target reinforced soil slope, wherein the force equilibrium equation includes Equation (1) and Equation (2):

$$σ {h}^{′} - τ = \frac{d E}{d x} - {p}_{x} - {τ}_{R} , \qquad ( 1 )$$

$$σ + τ {h}^{′} = {w}_{γ} + {σ}_{R} + {p}_{z} - \frac{d T}{d x} , \qquad ( 2 )$$

the moment equilibrium equation is Equation (3):

$${h}^{′} E - T = \frac{d M}{d x} - ( h - {h}_{s} ) {p}_{x} - {τ}_{R} ( h - {h}_{R} ) , \qquad ( 3 )$$

where in Equation (1), τ_{R} denotes a shear stress of the reinforcement material, and in Equation (2), σ_{R} denotes an axial stress of the reinforcement material, with

$${τ}_{R} = \frac{d {T}_{R x y}}{d x} and {σ}_{R} = \frac{d {T}_{R x y}}{d z} ,$$

and T_{Rxy} denotes a tension in a reinforcement layer;
establishing a moment equation for any point within the cross-section of the target reinforced soil slope based on the moment equilibrium equation, wherein the moment equation for any point (x_{R}, z_{R}) within the cross-section of the target reinforced soil slope is Equation (4):

$$\frac{d}{d x} [ ( h - {z}_{R} ) E - ( x - {x}_{R} ) T - M ] = ( h - {z}_{R} ) \frac{d E}{d x} - ( x - {x}_{R} ) \frac{d T}{d x} - ( h - {h}_{s} ) {p}_{x} - {τ}_{R} ( h - {h}_{R} ) , \qquad ( 4 )$$

establishing a soil yield function considering a stability function, wherein the soil yield function considering the stability function is Equation (5):

$$f = τ - \frac{1}{{F}_{s}} [ ( σ - u ) tan φ + c ] = 0 , \qquad ( 5 )$$

where in Equation (5), f denotes the soil yield function, Fₛ denotes a stability factor,

$${F}_{s} = \frac{{M}_{R}}{{M}_{0}} ,$$

wherein M_{R} denotes a sliding moment, M₀ denotes a resisting moment, u denotes a pore water pressure, φ denotes an internal friction angle of the soil, and c denotes a cohesion of the soil;

establishing a relationship between the force equilibrium equation, the moment equation for any point within the cross-section, and the soil yield function based on Equation (6):

$$( 1 + {h}^{{′λ}_{f}} ) \frac{dE}{dx} + ( {h}^{′} - {λ}_{F} ) \frac{dT}{dx} = ( {h}^{′} - {λ}_{F} ) [ {w}_{γ} + {p}_{z} + {σ}_{R} ] - ( 1 + {h}^{′2} ) {c}_{F} + ( 1 + {h}^{{′λ}_{F}} ) ( {p}_{x} + {τ}_{R} ) , \qquad ( 6 )$$

where in Equation (6), Δ_{F} denotes an internal friction angle parameter considering the stability factor,

$${λ}_{F} = \frac{tan φ}{{F}_{s}} ;$$

adding Equation (4) and Equation (6) multiplied by (h−z_{R}) to obtain Equation (7):

$$\frac{d}{dx} [ ( h - {z}_{R} ) E - ( x - {x}_{R} ) T - M ] = ( h - {z}_{R} ) \frac{dE}{dx} - ( x - {x}_{R} ) \frac{dT}{dx} - ( h - {h}_{s} ) {p}_{x} - {τ}_{R} ( h - {h}_{R} ) + ( {h}^{′} - {λ}_{F} ) ( h - {z}_{R} ) [ {w}_{γ} + {p}_{z} + {σ}_{R} ] - ( 1 + {h}^{′2} ) ( h - {z}_{R} ) {c}_{F} + ( 1 + {h}^{{′λ}_{F}} ) ( h - {z}_{R} ) ( {p}_{x} + {τ}_{R} ) - ( 1 + {h}^{{′λ}_{F}} ) ( h - {z}_{R} ) \frac{dE}{dx} - ( {h}^{′} - {λ}_{F} ) ( h - {z}_{R} ) \frac{dT}{dx} = - {h}^{{′λ}_{F}} ( h - {z}_{R} ) \frac{dE}{dx} - [ ( {h}^{′} - {λ}_{F} ) ( h - {z}_{R} ) - ( x - {x}_{R} ) ] \frac{dT}{dx} + ( {h}^{′} + {λ}_{F} ) ( h - {z}_{R} ) [ {w}_{γ} + {p}_{z} + {σ}_{R} ] - ( 1 + {h}^{′2} ) ( h - {z}_{R} ) {c}_{F} + ( 1 + {h}^{{′λ}_{F}} ) ( h - {z}_{R} ) ( {p}_{x} + {τ}_{R} ) - ( h - {h}_{s} ) {p}_{x} - {τ}_{R} ( h - {h}_{R} ) , \qquad ( 7 )$$

determining the resisting moment of the target reinforced soil slope, wherein when the sliding surface is circular, x−x_{R}=−h′(h−z_{R}), and Equation (7) becomes Equation (8):

$$\frac{d}{dx} [ ( h - {z}_{R} ) E - ( x - {x}_{R} ) T - M ] = - {h}^{{′λ}_{F}} ( h - {z}_{R} ) \frac{dE}{dx} + {λ}_{F} ( h - {z}_{R} ) \frac{dT}{dx} + ( {h}^{′} - {λ}_{F} ) ( h - {z}_{R} ) [ {w}_{γ} + {p}_{z} + {σ}_{R} ] - ( 1 + {h}^{′ 2} ) ( h - {z}_{R} ) {c}_{F} + ( 1 + {h}^{{′λ}_{F}} ) ( h - {z}_{R} ) ( {p}_{x} + {τ}_{R} ) - ( h - {h}_{s} ) {p}_{x} - {τ}_{R} ( h - {h}_{R} ) = ( {h}^{′} - {λ}_{F} ) ( h - {z}_{R} ) [ {w}_{γ} + {p}_{z} + {σ}_{R} ] - ( 1 + {h}^{′ 2} ) ( h - {z}_{R} ) {c}_{F} + ( 1 + {h}^{{′λ}_{F}} ) ( h - {z}_{R} ) ( {p}_{x} + {τ}_{R} ) - ( h - {h}_{s} ) {p}_{x} - {τ}_{R} ( h - {h}_{R} ) - {λ}_{F} ( h - {z}_{R} ) ( {h}^{′ \frac{dE}{dx}} - \frac{dT}{dx} ) , \qquad ( 8 )$$

applying a same assumption as for an unreinforced soil slope, setting

$${h}^{′ \frac{dE}{dx}} - \frac{dT}{dx} = 0 ,$$

and integrating Equation (7) to obtain Equation (9):

$${\int }_{{x}_{0}}^{{x}_{N}} [ ( {h}^{′} - {λ}_{F} ) ( h - {z}_{R} ) ( {w}_{γ} + {p}_{z} + {σ}_{R} ) - ( 1 + {h}^{′ 2} ) ( h - {z}_{R} ) {c}_{F} + ( 1 + {h}^{′} {λ}_{F} ) ( h - {z}_{R} ) ( {p}_{x} + {τ}_{R} ) - ( h - {h}_{s} ) {p}_{x} - {τ}_{R} ( h - {h}_{R} ) ] dx = 0$$

which is rearranged as:

$${\int }_{{x}_{0}}^{{x}_{N}} [ ( {x}_{R} - x ) ( {w}_{γ} + {p}_{z} + {σ}_{R} ) + ( {h}_{s} - {z}_{R} ) {p}_{x} + ( {h}_{R} - {z}_{R} ) {τ}_{R} - {λ}_{F} ( h - {z}_{R} ) ( {w}_{γ} + {p}_{z} + {σ}_{R} ) - ( 1 + {h}^{′ 2} ) ( h - {z}_{R} ) {c}_{F} - {λ}_{F} ( x - {x}_{R} ) {p}_{x} - {λ}_{F} ( x - {x}_{R} ) {τ}_{R} ] dx = 0 , \qquad ( 9 )$$

where in Equation (9), x₀ denotes an x-coordinate of an intersection point between the sliding surface and a slope top, and x_{N} denotes an x-coordinate of an intersection point between the sliding surface and a ground surface;
rearranging Equation (9) to obtain an expression for the resisting moment of the target reinforced soil slope, i.e., Equation (10):

$${M}_{0} = {\int }_{{x}_{0}}^{{x}_{N}} [ ( {x}_{R} - x ) ( {w}_{γ} + {p}_{z} ) + ( {h}_{s} - {z}_{R} ) {p}_{x} ] dx , \qquad ( 10 )$$

determining the sliding moment of the target reinforced soil slope;
in response to the reinforcement layer being horizontally placed and τ_{R} being a constant, from Equation (9) and Equation (10), an Equation is obtained:

$$\begin{matrix}{M}_{R} = {\int }_{{x}_{0}}^{{x}_{N}} [ \begin{matrix}λ ( h - {z}_{R} ) ( {w}_{γ} + {p}_{z} ) + ( 1 + {h}^{′ 2} ) ( h - {z}_{R} ) c + \\ λ ( x - {x}_{R} ) {p}_{x} + λ ( - {x}_{R} ) {τ}_{R} - {F}_{s} ( {h}_{R} - {z}_{R} ) {τ}_{R}\end{matrix} ] dx \\ = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + \\ λ ( x - {x}_{R} ) {p}_{x} + λ ( x - {x}_{R} ) {τ}_{R} ] dx - {F}_{s} {τ}_{R} ( {h}_{R} - {z}_{R} ) ( {x}_{B} - {x}_{k} ) ,\end{matrix}$$

Equation (11) is obtained by rearranging:

$${M}_{R} = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + λ ( x - {x}_{R} ) {p}_{x} + λ ( x - {x}_{R} ) {τ}_{R} ] dx - {F}_{s} {τ}_{R} ( {h}_{R} - {z}_{R} ) ( {x}_{B} - {x}_{k} ) , \qquad ( 11 )$$

setting −τ_{R}(x_{B}−xₖ)=T_{R}, T_{R} denotes a designed tensile strength per unit width of the reinforcement material, x_{B} denotes an x-coordinate of a right slope toe, and xₖ denotes an x-coordinate of an intersection point between the sliding surface and a soil slope bottom surface, yields:

$${M}_{R} = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + λ ( x - {x}_{R} ) {p}_{x} + λ ( x - {x}_{R} ) {τ}_{R} ] dx + {F}_{s} {T}_{R} ( {h}_{R} - {z}_{R} )$$

and the sliding moment of the target reinforced soil slope is rearranged and expressed as Equation (12):

$${M}_{R} = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + λ ( x - {x}_{R} ) {p}_{x} ] dx + {\int }_{{x}_{k}}^{{x}_{B}} [ λ ( x - {x}_{R} ) \frac{{T}_{R}}{{x}_{k} - {x}_{B}} ] dx + {F}_{s} {T}_{R} ( {h}_{R} - {z}_{R} ) , \qquad ( 12 )$$

where λ denotes a tangent of the internal friction angle of the soil, λ=tanφ;
establishing a stability factor calculation model for the target reinforced soil slope based on the resisting moment and the sliding moment using Equation (13):

$$\begin{matrix}{F}_{s} = \frac{{M}_{R}}{{M}_{0}} \\ = \frac{\begin{matrix}{\int }_{{x}_{0}}^{{x}_{N}} [ λ ( h - {z}_{R} ) ( {w}_{γ} + {p}_{z} ) + ( 1 + {h}^{′2} ) ( h - {z}_{R} ) c + λ ( x - {x}_{R} ) {p}_{x} ] dx + \\ {\int }_{{x}_{k}}^{{x}_{B}} [ λ ( x - {x}_{R} ) \frac{{T}_{R}}{{x}_{k} - {x}_{B}} ] dx + {F}_{s} {T}_{R} ( {h}_{R} - {z}_{R} )\end{matrix}}{{\int }_{{x}_{0}}^{{x}_{N}} [ ( {x}_{R} - x ) ( {w}_{γ} + {p}_{z} ) + ( {h}_{s} - {z}_{R} ) {p}_{x} ] dx} ,\end{matrix} \qquad ( 13 )$$

selecting a plurality of arbitrary points (x_{R}, z_{R}) within the cross-section of the target reinforced soil slope, and inputting information into the stability factor calculation model for the target reinforced soil slope, the information including:
the vertical load of the soil slope surface, the horizontal load of the soil slope surface, the unit weight of the soil, the internal friction angle of the soil, the cohesion of the soil, the designed tensile strength per unit width of the reinforcement material, the x-coordinate of the right slope toe, the x-coordinate of the intersection point between the sliding surface and the soil slope bottom surface, the x-coordinate of the intersection point between the sliding surface and the slope top, and the x-coordinate of the intersection point between the sliding surface and the ground surface, calculating the stability factor for each point (x_{R}, z_{R}) according to the stability factor calculation model for the target reinforced soil slope, and
selecting a smallest stability factor as a final stability factor of the target reinforced soil slope to evaluate stability of the target reinforced soil slope.

Embodiments of the present disclosure include at least the following beneficial effect: the method of the present disclosure takes into account the influence of the reinforcement layer on the stability of the soil slope, which substantially reduces the assumption conditions, and calculates the stability factor with higher accuracy.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a flowchart illustrating an exemplary process for stability analysis of a reinforced soil slope considering a uniformly distributed frictional resistance between soil and a reinforcement material according to some embodiments of the present disclosure.

FIG. 2 is a schematic diagram illustrating an exemplary hardware and software components of an exemplary computing device according to some embodiments of the present disclosure.

### DETAILED DESCRIPTION

In order to provide a clearer understanding of the technical solutions of the embodiments described in the present disclosure, a brief introduction to the drawings required in the description of the embodiments is given below. It is evident that the drawings described below are merely some examples or embodiments of the present disclosure, and for those skilled in the art, the present disclosure may be applied to other similar situations without exercising creative labor. Unless otherwise indicated or stated in the context, the same reference numerals in the drawings represent the same structures or operations.

It should be understood that the terms “system,” “device,” “unit,” and/or “module” used herein are ways for distinguishing different levels of components, elements, parts, or assemblies. However, if other terms can achieve the same purpose, they may be used as alternatives.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to the embodiments described herein. It should be understood that the operations may not necessarily be performed in the exact sequence depicted. Instead, the operations may be performed in reverse order or concurrently. Additionally, other operations may be added to these processes, or one or more operations may be removed.

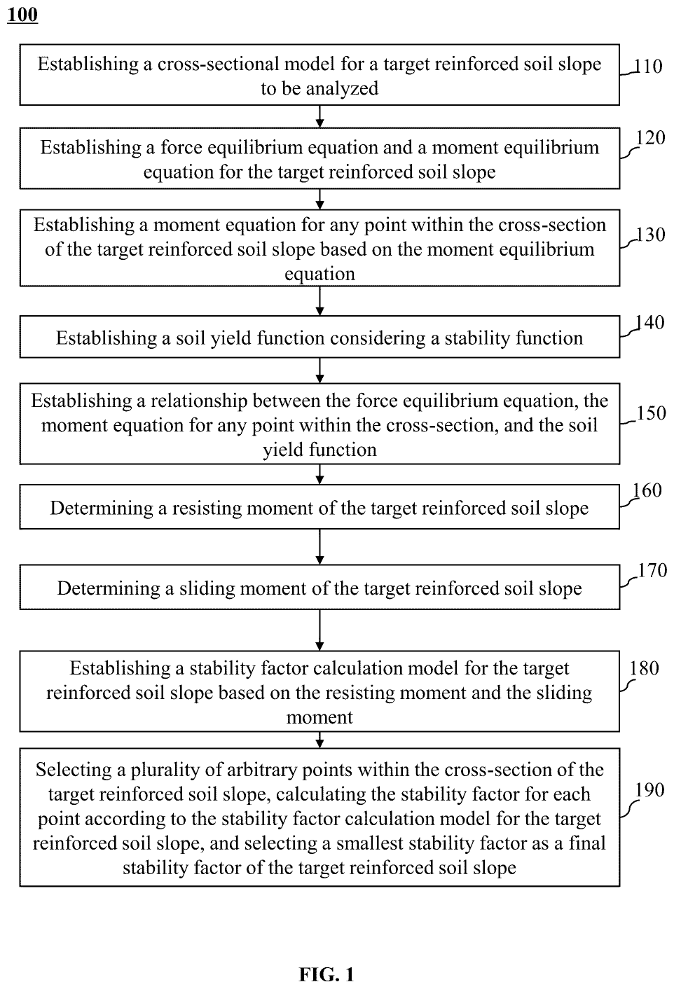

FIG. 1 is a flowchart illustrating an exemplary process 100 for stability analysis of a reinforced soil slope considering a uniformly distributed frictional resistance between soil and a reinforcement material according to some embodiments of the present disclosure. As shown in FIG. 1, the process 100 includes the following operations. In some embodiments, the process 100 may be executed by a processor of a system for stability analysis of a reinforced soil slope. The processor may process data and/or information obtained from other devices (e.g., a storage device, a detection device, etc.). The processor may execute program instructions based on the data, information, and/or processing results to perform one or more of the functions described in the present disclosure. In some embodiments, the processor may include one or more sub-processing devices (e.g., a single-core processing device or a multi-core processing device). Merely by way of example, the processor may include a central processing unit (CPU), an application-specific integrated circuit (ASIC), an application-specific instruction processor (ASIP), a graphics processor (GPU), a physical processor (PPU), a digital signal processor (DSP), a field-programmable gate array (FPGA), a programmable logic circuit (PLD), a controller, a microcontroller unit, a refined instruction set Computer (RISC), microprocessor, etc., or any combination thereof.

The storage device may be used to store data and/or instructions. The storage device may include one or more storage components, each of the storage components may be a stand-alone device or a part of other devices. In some embodiments, the storage device may include a random-access memory (RAM), a read-only memory (ROM), a mass storage, a removable memory, a volatile read/write memory, etc., or any combination thereof. For example, the mass storage device may include a disk, an optical disk, a solid-state disk, or the like. In some embodiments, the storage device may be implemented on a cloud platform.

The detection device may include a soil physical property detection device (e.g., a static touchdown device, a power touchdown device, a cross plate shear device, a nucleon density meter, etc.), a deformation and displacement monitoring device (e.g., a total station, an inclinometer, a fiber-optic strain sensor, a laser scanner, etc.), a stress and pore water pressure monitoring device (e.g., an earth pressure box, a pore water pressure meter, a reinforcement meter, etc.), etc. The detection device may communicate with the processor via a network, to transmit detected data to the processor for processing.

In 110, a cross-sectional model for a target reinforced soil slope to be analyzed may be established. The establishing process includes establishing computational relationships for the target reinforced soil slope including: a vertical load of a soil slope surface, a horizontal load of the soil slope surface, a unit weight per unit width of soil, a horizontal force of a slope body, a vertical shear force of the slope body, and a soil moment.

The target reinforced soil slope refers to a soil slope structure that is to be stabilized by setting the reinforcement material in the soil body to enhance stability. For example, the target reinforced soil slope may include a slope composed of naturally occurring soils, an artificially filled embankment, a foundation slope surrounding buildings, or the like.

The cross-sectional model refers to a two-dimensional mechanical model configured to convert a three-dimensional soil slope to a cross-section for analysis. The cross-section refers to a two-dimensional view intercepted along a longitudinal direction of the target reinforced soil slope. The longitudinal direction of the target reinforced soil slope is a lengthwise direction of the target reinforced soil slope. For example, the cross-sectional model may be one or a combination of a two-dimensional strain model, a two-dimensional limit equilibrium model, or the like.

For the convenience of the analysis, a three-dimensional coordinate system may be constructed. The X-axis of the three-dimensional coordinate system represents a transverse direction (i.e., along a horizontal direction) of the cross-section of the target reinforced soil slope. The Z-axis of the three-dimensional coordinate system represents a vertical direction, (i.e., along a perpendicular direction) of the cross-section of the target reinforced soil slope. The Y-axis is perpendicular to the cross-section (i.e., the XZ plane) of the target reinforced soil slope (i.e., along the longitudinal direction of the soil slope).

In some embodiments, the cross-sectional model may correspond to the XZ plane of the target reinforced soil slope.

The vertical load of the soil slope surface refers to a vertically distributed force acting on the soil slope surface. For example, the vertical load of the soil slope surface includes a vertical external force such as a pile load at a top of the slope, a vehicle load, or a projection component of the sliding surface stress in the vertical direction.

In some embodiments, the vertical load of the soil slope surface: p_{z}= (σ+τh′)Γₛ, where p_{z} denotes the vertical load of the soil slope surface, σ denotes a normal stress on the sliding surface, τ denotes a tangential shear stress on the sliding surface, h denotes a boundary function of the sliding surface, h′ denotes a slope of the sliding surface, and Γ'ₛ denotes a boundary function of the soil slope surface, where Γₛ:z=hₛ (x), hₛ denotes a boundary function of the soil slope surface, in a two-dimensional soil slope, hₛ may be understood as a vertical coordinate of the soil slope surface.

The sliding surface refers to a plane or curved surface within a soil slope where sliding failure may occur. For example, the sliding surface may be a curved surface or a folded surface along which shear sliding most likely progresses during soil body instability. In some embodiments, the processor may obtain the sliding surface based on any feasible means, such as a limit equilibrium manner.

Exemplarily, by assuming different sliding surface shapes (e.g., circular) and iteratively calculating corresponding safety factors, the processor may select the sliding surface corresponding to the smallest safety factor as the sliding surface h. In some embodiments, the sliding surface may also be determined by automated search through a software (e.g., GeoStudio, PLAXIS).

The normal stress on the sliding surface refers to a stress component acting perpendicularly to the sliding surface. In some embodiments, the normal stress on the sliding surface may be determined by the processor through establishing a force equilibrium equation in combined with soil body properties. More descriptions of the force equilibrium equation may be found in the related descriptions of operation 120. The tangential shear stress on the sliding surface refers to a shear stress acting on the sliding surface and parallel to the sliding surface. In some embodiments, the tangential shear stress on the sliding surface may be determined by the processor through establishing the force equilibrium equation in combined with the soil body properties.

The horizontal load of the soil slope surface refers to a distributed force acting in the horizontal direction on the soil slope surface. For example, the horizontal load of the soil slope surface includes horizontal external forces such as seismic inertia forces, wind loads, etc., or the projection components of the sliding surface stresses in the horizontal direction.

In some embodiments, the horizontal load of the soil slope surface: pₓ= (τ—σh′)Γₛ, where pₓ denotes the horizontal load of the soil slope surface.

The unit weight per unit width of soil refers to gravity of the soil body from a slope surface to the sliding surface per unit width of the target reinforced soil slope. In some embodiments, a width weight per unit of the soil body is used to describe the distribution of the weight of the soil body per unit width.

$${w}_{γ} = {\int }_{{h}_{s}}^{h} γ dz ,$$

In some embodiments, the unit weight per unit width of soil:

where w_{γ} denotes the unit weight per unit width of soil; γ denotes a unit weight of soil, and hₛ denotes the boundary function of the soil slope surface.

The unit weight of soil refers to a mass or weight of the soil body per unit volume. In some embodiments, a technician may obtain the unit weight of soil by an experimental determination method, an empirical estimation method, or the like, and input the unit weight of soil into the processor. Exemplarily, the experimental determination method may allow the technician to determine a dry density by oven-drying and weighing soil samples in a laboratory, combined with the volume of the soil samples, and then the unit weight of soil may be obtained. As another example, the empirical estimation method may enable the technician to determine the unit weight of soil by referencing existing data under analogous geological conditions or consulting typical values in standardized manuals.

The horizontal force of the slope body refers to a sum of all forces acting inside or on the soil slope along the horizontal direction (i.e., the X-axis direction).

The horizontal force of the slope body may be expressed as

$$E = {\int }_{{h}_{s}}^{h} {σ}_{x} dz ,$$

where E denotes the horizontal force of the slope body; σₓ denotes a stress in an x-direction of the slope body.

The stress in the x-direction of the slope body refers to a stress component acting inside the soil slope along the X-axis direction. In some embodiments, the stress in the x-direction of the slope body may be determined by the processor through establishing the force equilibrium equation combined with the soil body properties.

The vertical shear force of the slope body refers to a shear force inside the soil slope along the perpendicular direction (i.e., the Z-axis direction).

In some embodiments, the vertical shear force of the slope body:

$$T = {\int }_{{h}_{s}}^{h} {τ}_{xz} dz ;$$

where T denotes the vertical shear force of the slope body; τ_{xz} denotes a vertical shear stress of the slope body; and xz denotes a cross-section of the target reinforced soil slope.

The way of obtaining the vertical shear stress of the slope body is similar to that of obtaining the stress in the x-direction of the slope body, and will not be repeated here.

The soil moment refers to a rotational effect generated by a force applied to the soil body about a specific reference point or axis. In some embodiments, the soil moment may be used to assess the stability of the soil slope.

In some embodiments, the soil moment:

$$M = {\int }_{{h}_{s}}^{h} {σ}_{x} ( h - z ) dz ,$$

where M denotes the soil moment; and z denotes a vertical direction of the cross-section of the target reinforced soil slope.

In 120, the force equilibrium equation and the moment equilibrium equation for the target reinforced soil slope may be established.

In some embodiments, the force equilibrium equation includes Equation (1) and Equation (2):

$$σ {h}^{′} - τ = \frac{dE}{dx} - {p}_{x} - {τ}_{R} , \qquad ( 1 )$$

$$σ + τ {h}^{′} = {W}_{γ} + {σ}_{R} + {p}_{z} - \frac{dT}{dx} . \qquad ( 2 )$$

In some embodiments, the moment equilibrium equation is Equation (3):

$${h}^{′} E - T = \frac{dM}{dx} - ( h - {h}_{s} ) {p}_{x} - {τ}_{R} ( h - {h}_{R} ) . \qquad ( 3 )$$

In Equation (1), τ_{R} denotes a shear stress of the reinforcement material, and σ_{R} denotes an axial stress of the reinforcement material, where

$${τ}_{R} = \frac{{dT}_{Rxy}}{dx} , {σ}_{R} = \frac{{dT}_{Rxy}}{dz} ;$$

T_{Rxy} denotes a tension in a reinforcement layer; and h_{R} denotes a location of the reinforcement material.

The shear stress of the reinforcement material refers to a shear stress acting on the reinforcement material inside the target reinforced soil slope.

The axial stress of the reinforcement material refers to a stress generated by an axial force acting on the reinforcement material inside the target reinforced soil slope. The axial force is a force along a length direction of the reinforcement material.

The tension in the reinforcement layer refers to a tensile force borne by the reinforcement material which is added inside the target reinforced soil slope.

In 130, a moment equation may be established for any point within the cross-section of the target reinforced soil slope based on the moment equilibrium equation.

In some embodiments, the moment equation for any point (x_{R}, z_{R}) within the cross-section of the target reinforced soil slope is Equation (4):

$$\frac{d}{dx} [ ( h - {z}_{R} ) E - ( x - {x}_{R} ) T - M ] = ( h - {z}_{R} ) \frac{dE}{dx} - ( x - {x}_{R} ) \frac{dT}{dx} - ( h - {h}_{s} ) {p}_{x} - {τ}_{R} ( h - {h}_{R} ) . \qquad ( 4 )$$

In Equation (4), x_{R} denotes a horizontal coordinate of any point within the cross-section of the target reinforced soil slope; z_{R} denotes a vertical coordinate of any point within the cross-section of the target reinforced soil slope.

In 140, a soil yield function considering a stability function may be established.

In some embodiments, the soil yield function considering the stability function is Equation (5):

$$f = τ - \frac{1}{{F}_{s}} [ ( σ - u ) tan φ + c ] = 0. \qquad ( 5 )$$

In Equation (5), f denotes the soil yield function; Fₛ denotes a stability factor;

$${F}_{s} = \frac{{M}_{R}}{{M}_{0}} ,$$

where M_{R} denotes a sliding moment; and M₀ denotes a resisting moment; u denotes a pore water pressure; φ denotes an internal friction angle of the soil; c denotes a cohesion of the soil.

The stability factor refers to a parameter used to assess the stability of the target reinforced soil slope.

The sliding moment refers to a sum of moments acting on the target reinforced soil slope that may lead to a sliding of the soil body. More descriptions of determining the sliding moment may be found in the related descriptions of operation 170.

The resisting moment refers to a sum of moments acting on the target reinforced soil slope that resists a sliding of the soil body. More descriptions of determining the resisting moment may be found in the related descriptions of operation 160.

The pore water pressure refers to a pressure exerted by water within void spaces between soil particles. In some embodiments, the technician may obtain the pore water pressure through a pore water manometer, a seepage manometer, or the like.

The internal friction angle of the soil refers to an angle corresponding to a frictional resistance generated by relative sliding between particles within the soil body. In some embodiments, the technician may obtain the internal friction angle of the soil through a laboratory testing, a field testing, or the like. The laboratory testing may be used by the technician to determine the internal friction angle of the soil samples through ways such as direct shear tests or triaxial compression tests. The field testing may be in-situ testing conducted by the technician, such as a standard penetration test (SPT) or a cone penetration test (CPT), with results converted to the internal friction angle through empirical correlations.

The cohesion of the soil refers to cohesive strength arising from physical or chemical bonding among particles within the soil body. In some embodiments, the way of obtaining the cohesion of the soil is similar to the way of obtaining the friction angle of the soil body, and will not be repeated here.

In 150, a relationship between the force equilibrium equation, the moment equation for any point within the cross-section, and the soil yield function may be established.

In some embodiments, the processor may couple Equation (1), Equation (2), and Equation (5) to obtain Equation (6):

$$( 1 + {h}^{{′λ}_{F}} ) \frac{dE}{dx} + ( {h}^{′} - {λ}_{F} ) \frac{dT}{dx} = ( {h}^{′} - {λ}_{F} ) [ {w}_{γ} + {p}_{z} + {σ}_{R} ] - ( 1 + {h}^{′ 2} ) {c}_{F} + ( 1 + {h}^{{′λ}_{F}} ) ( {p}_{x} + {τ}_{R} ) . \qquad ( 6 )$$

In Equation (6), λ_{F} denotes an internal friction angle parameter considering the stability factor, and

$${λ}_{F} = \frac{tan φ}{{F}_{s}} .$$

In some embodiments, the processor may add Equation (4) and Equation (6) multiplied by (h−z_{R}) to obtain Equation (7):

$$\frac{d}{dx} [ ( h - {z}_{R} ) E - ( x - {x}_{R} ) T - M ] = ( h - {z}_{R} ) \frac{dE}{dx} - ( x - {x}_{R} ) \frac{dT}{dx} - ( h - {h}_{s} ) {p}_{x} - {τ}_{R} ( h - {h}_{R} ) + ( {h}^{′} - {λ}_{F} ) ( h - {z}_{R} ) [ {w}_{γ} + {p}_{z} + {σ}_{R} ] - ( 1 + {h}^{′ 2} ) ( h - {z}_{R} ) {c}_{F} + ( 1 + {h}^{{′λ}_{F}} ) ( h - {z}_{R} ) ( {p}_{x} + {τ}_{R} ) - ( 1 + {h}^{{′λ}_{F}} ) ( h - {z}_{R} ) \frac{dE}{dx} - ( {h}^{′} - {λ}_{F} ) ( h - {z}_{R} ) \frac{dT}{dx} = - {h}^{{′λ}_{F}} ( h - {z}_{R} ) \frac{dE}{dx} - [ ( {h}^{′} - {λ}_{F} ) ( h - {z}_{R} ) - ( x - {x}_{R} ) ] \frac{dT}{dx} + ( {h}^{′} - {λ}_{F} ) ( h - {z}_{R} ) [ {w}_{γ} + {p}_{z} + {σ}_{R} ] - ( 1 + {h}^{′ 2} ) ( h - {z}_{R} ) {c}_{F} + ( 1 + {h}^{{′λ}_{F}} ) ( h - {z}_{R} ) ( {p}_{x} + {τ}_{R} ) - ( h - {h}_{s} ) {p}_{x} - {τ}_{R} ( h - {h}_{R} ) . \qquad ( 7 )$$

In 160, the resisting moment of the target reinforced soil slope may be determined.

In some embodiments, when the sliding surface is circular, x−x_{R}=−h′ (h−z_{R}), the processor may rearrange Equation (7) into Equation (8):

$$\frac{d}{dx} [ ( h - {z}_{R} ) E - ( x - {x}_{R} ) T - M ] = - {h}^{{′λ}_{F}} ( h - {z}_{R} ) \frac{dE}{dx} + {λ}_{F} ( h - {z}_{R} ) \frac{dT}{dx} + ( {h}^{′} - {λ}_{F} ) ( h - {z}_{R} ) [ {w}_{γ} + {p}_{z} + {σ}_{R} ] - ( 1 + {h}^{′ 2} ) ( h - {z}_{R} ) {c}_{F} + ( 1 + {h}^{{′λ}_{F}} ) ( h - {z}_{R} ) ( {p}_{x} + {τ}_{R} ) - ( h - {h}_{s} ) {p}_{x} - {τ}_{R} ( h - {h}_{R} ) = ( {h}^{′} - {λ}_{F} ) ( h - {z}_{R} ) [ {w}_{γ} + {p}_{z} + {σ}_{R} ] - ( 1 + {h}^{′ 2} ) ( h - {z}_{R} ) {c}_{F} + ( 1 + {h}^{{′λ}_{F}} ) ( h - {z}_{R} ) ( {p}_{x} + {τ}_{R} ) - ( h - {h}_{s} ) {p}_{x} - {τ}_{R} ( h - {h}_{R} ) - {λ}_{F} ( h - {z}_{R} ) ( {h}^{′ \frac{dE}{dx}} - \frac{dT}{dx} ) . \qquad ( 8 )$$

By applying a same assumption as for an unreinforced soil slope, setting

$${h}^{′ \frac{dE}{dx}} - \frac{dT}{dx} = 0 ,$$

and integrating Equation (7), Equation (9) is obtained:

$${\int }_{{x}_{0}}^{{x}_{N}} [ ( {h}^{′} - {λ}_{F} ) ( h - {z}_{R} ) ( {w}_{γ} + {p}_{z} + {σ}_{R} ) - ( 1 + {h}^{′2} ) ( h - {z}_{R} ) {c}_{F} + ( 1 + {h}^{′} {λ}_{F} ) ( h - {z}_{R} ) ( {p}_{x} + {τ}_{R} ) - ( h - {h}_{s} ) {p}_{x} - {τ}_{R} ( h - {h}_{R} ) ] dx = 0 , \qquad ( 9 )$$

which is rearranged as:

$${\int }_{{x}_{0}}^{{x}_{N}} [ ( {x}_{R} - x ) ( {w}_{γ} + {p}_{z} + {σ}_{R} ) + ( {h}_{s} - {z}_{R} ) {p}_{x} + ( {h}_{R} - {z}_{R} ) {τ}_{R} - {λ}_{F} ( h - {z}_{R} ) ( {w}_{γ} + {p}_{z} + {σ}_{R} ) - ( 1 + {h}^{′ 2} ) ( h - {z}_{R} ) {c}_{F} - {λ}_{F} ( x - {x}_{R} ) {p}_{x} - {λ}_{F} ( x - {x}_{R} ) {τ}_{R} ] dx = 0. \qquad ( 9 )$$

In Equation (9), x₀ denotes an x-coordinate of an intersection point between the sliding surface and a slope top; x_{N} denotes an x-coordinate of an intersection point between the sliding surface and a ground surface.

In some embodiments, the processor may rearrange Equation (9) to obtain an expression for the resisting moment of the target reinforced soil slope, i.e., Equation (10):

$${M}_{0} = {\int }_{{x}_{0}}^{{x}_{N}} [ ( {x}_{R} - x ) ( {w}_{γ} + {p}_{z} ) + ( {h}_{s} - {z}_{R} ) {p}_{x} ] dx . \qquad ( 10 )$$

In some embodiments, the processor may divide the sliding surface into a plurality of sub-regions and determine respective resisting moments of the plurality of sub-regions; synthesize the respective resisting moments of the plurality of sub-regions within the sliding surface into a plurality of localized resisting moment segments; and splice adjacent resisting moment segments within the sliding surface while excluding those resisting moment segments whose boundaries cannot be properly aligned; and assemble the retained resisting moment segments to constitute the resisting moment of the sliding surface.

It should be noted that when dividing the sliding surface into the plurality of sub-regions and determining the respective resisting moments of the plurality of sub-regions, x₀ in Equation (10) may be the x-coordinate of an intersection point between an extension line of a sub-region and the slope top; and x_{N} may be the x-coordinate of an intersection point between the extension line of the sub-region and the ground surface

The preceding “synthesize,” “splice,” and “exclude” are computational data processing manners, the embodiments of the present disclosure do not have a special limitation on these data processing manners, and may employ well-established practices known to those skilled in the art.

In 170, the sliding moment of the target reinforced soil slope may be determined.

In some embodiments, in response to the reinforcement layer being horizontally placed and τ_{R} being a constant (i.e., the friction between the soil and the reinforcement material follows a rectangular distribution), from Equation (9) and Equation (10), an Equation is obtained:

$${M}_{R} = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + λ ( x - {x}_{R} ) {p}_{x} + λ ( - {x}_{R} ) {τ}_{R} - {F}_{s} ( {h}_{R} - {z}_{R} ) {τ}_{R} ] dx = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + λ ( x - {x}_{R} ) {p}_{x} + λ ( x - {x}_{R} ) {τ}_{R} ] dx - {F}_{S} {τ}_{R} ( {h}_{R} - {z}_{R} ) ( {x}_{B} - {x}_{k} ) .$$

Equation (11) is obtained by rearranging:

$${M}_{R} = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + λ ( x - {x}_{R} ) {p}_{x} + λ ( x - {x}_{R} ) {τ}_{R} ] dx - {F}_{S} {τ}_{R} ( {h}_{R} - {z}_{R} ) ( {x}_{B} - {x}_{k} ) . \qquad ( 11 )$$

In some embodiments, the processor sets −τ_{R}(x_{B}−xₖ)=T_{R}, τ_{R} denotes a designed tensile strength per unit width of the reinforcement material, x_{B} denotes an x-coordinate of a right slope toe, and xₖ denotes an x-coordinate of an intersection point between the sliding surface and a soil slope bottom surface. The following equation may therefore be obtained:

$${M}_{R} = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + λ ( x - {x}_{R} ) {p}_{x} + λ ( x - {x}_{R} ) {τ}_{R} ] dx + {F}_{S} {T}_{R} ( {h}_{R} - {z}_{R} ) .$$

The sliding moment of the target reinforced soil slope is rearranged and expressed as Equation (12):

$${M}_{R} = {\int }_{{x}_{0}}^{{x}_{N}} [ λ ( h - {z}_{R} ) ( {w}_{γ} + {p}_{z} ) + ( 1 + {h}^{′ 2} ) ( h - {z}_{R} ) c + λ ( x - {x}_{R} ) {p}_{x} ] dx + {\int }_{{x}_{k}}^{{x}_{B}} [ λ ( x - {x}_{R} ) \frac{{T}_{R}}{{x}_{k} - {x}_{B}} ] dx + {F}_{S} {T}_{R} ( {h}_{R} - {z}_{R} ) . \qquad ( 12 )$$

In Equation (12), 2 denotes a tangent of the internal friction angle of the soil, and λ=tan φ.

The fact that the shear stress of the reinforcement material τ_{R} is a constant means that the shear stress inside the reinforcement material is kept constant during the analysis of the stability factor

In some embodiments, the processor may divide the sliding surface into a plurality of sub-regions and determine respective sliding moments of the plurality of sub-regions; synthesize the respective sliding moments of the plurality of sub-regions within the sliding surface into a plurality of localized sliding moment segments; splice adjacent sliding moment segments within the sliding surface while excluding those sliding moment segments whose boundaries cannot be properly aligned; and assemble the retained sliding moment segments to constitute the sliding moment of the sliding surface. The way of determining the sliding moment is similar to the way of determining the resisting moment, and will not be repeated here.

The preceding “synthesize,” “splice,” and “exclude” are computational data processing manners, the embodiments of the present disclosure do not have a special limitation on these data processing manners, and may employ well-established practices known to those skilled in the art.

In 180, a stability factor calculation model for the target reinforced soil slope may be established based on the resisting moment and the sliding moment.

The stability factor calculation model is a tool to evaluate stability of the target reinforced soil slope. In some embodiments, the processor may establish the stability factor calculation model for the target reinforced soil slope based on the resisting moment and the sliding moment.

In some embodiments, the processor may obtain the stability factor calculation model for the target reinforced soil slope based on Equation (10) and Equation (12), as Equation (13):

$${F}_{s} = \frac{{M}_{R}}{{M}_{0}} = \frac{\begin{matrix}{\int }_{{x}_{0}}^{{x}_{N}} [ λ ( h - {z}_{R} ) ( {w}_{γ} + {p}_{z} ) + ( 1 + h {′}^{2} ) ( h - {z}_{R} ) c + λ ( x - \\ {x}_{R} ) {p}_{x} ] dx + {\int }_{{x}_{k}}^{{x}_{B}} [ λ ( x - {x}_{R} ) \frac{{T}_{R}}{{x}_{k} - {x}_{B}} ] dx + {F}_{s} {T}_{R} ( {h}_{R} - {z}_{R} )\end{matrix}}{{\int }_{{x}_{0}}^{{x}_{N}} [ ( {x}_{R} - x ) ( {w}_{γ} + {p}_{z} ) + ( {h}_{s} - {z}_{R} ) {p}_{x} ] dx} . \qquad ( 13 )$$

It should be noted that in response to the reinforcement layer being horizontally placed, σ_{R}=0; and in response to there is no reinforcement layer that passes through the soil bar, σ_{R}=0, and τ_{R}=0.

In 190, a plurality of arbitrary points (x_{R}, z_{R}) within the cross-section of the target reinforced soil slope may be selected, and specific information may be inputted into the stability factor calculation model for the target reinforced soil slope obtained in operation 180. The specific information includes the vertical load of the soil slope surface, the horizontal load of the soil slope surface, the unit weight of the soil, the internal friction angle of the soil, the cohesion of the soil, the designed tensile strength per unit width of the reinforcement material, the x-coordinate of the right slope toe, the x-coordinate of the intersection point between the sliding surface and the soil slope bottom surface, the x-coordinate of the intersection point between the sliding surface and the slope top, and the x-coordinate of the intersection point between the sliding surface and the ground surface. The stability factor for each point (x_{R}, z_{R}) may be calculated according to the stability factor calculation model for the target reinforced soil slope (i.e., Equation 13), and a smallest stability factor may be selected as a final stability factor of the target reinforced soil slope to evaluate the stability of the target reinforced soil slope.

Some embodiments of the present disclosure, establishing the cross-sectional model and introducing the force equilibrium equation and the moment equilibrium equation enable more precise determination of stability of the soil slope. In combination with the soil yield function considering the stability function, the resisting moment and the sliding moment may be further determined, and the stability factor calculation model is proposed to evaluate the stability of the soil slope, thereby significantly enhancing the accuracy of determination, reducing the assumption conditions, and more authentically representing the impact of the reinforcement material on the stability of the soil slope. In practical application, a plurality of points are selected to determine the stability factor, which ensures the accuracy and reliability of the analysis results, optimizes the engineering design, enhances the safety of a structure of the soil slope, reduces the material waste, improves the economic efficiency, and provides technical justification for engineering practices, so as to achieve a more reasonable, safe, and efficient design goal.

In some embodiments, the processor may obtain strain of the reinforcement material at each of the predetermined point locations within the target reinforced soil slope; determine a degradation degree in performance of the reinforcement material based on the strain of the reinforcement material at each of the predetermined point locations within the target reinforced soil slope; determine the designed tensile strength per unit width T_{R} of the reinforcement material according to the degradation degree in the performance of the reinforcement material, and re-determine the stability factor for each of the predetermined point locations.

The strain of the reinforcement material refers to a relative deformation per unit length produced when the reinforcement material is subjected to loading. The unit length may be determined by a predetermined setting, for example, 1 m.

In some embodiments, the technician may pre-set strain sensors in wireless communication with the processor at a plurality of predetermined point locations of the reinforced soil slope, and the processor may obtain the strain of the reinforcement material at each of the predetermined point locations by communicating with the plurality of strain sensors.

In some embodiments, the strain sensors may include resistance strain gauges, grating strain gauges, or the like.

The degradation degree in the performance of the reinforcement material refers to a degree to which the tensile property of the reinforcement material is degraded as a result of negative factors. In some embodiments, the negative factors may include prolonged stress, environmental corrosion, fatigue accumulation, or the like. The degradation degree in the performance of the reinforcement material may be expressed as a percentage, for example, an 80% degradation degree in the performance of the reinforcement material indicates that 80% of the original tensile property has been lost, and current reinforcement material retains only 20% of its as-manufactured tensile property.

In some embodiments, the processor may determine the degradation degree in the performance of the reinforcement material based on the strain of the reinforcement material at each of the predetermined point locations in the target reinforced soil slope through a variety of manners, for example, determining by a degradation prediction model.

In some embodiments, the degradation prediction model may be a machine learning model, such as a neural network (NN), etc. An input to the degradation prediction model may include the strain of the reinforcement material and environmental data for each of the predetermined point locations in the target reinforced soil slope, and an output may include the degradation degree in the performance of the reinforcement material.

The environmental data refers to data that reflects the geographic environment in which the target reinforced soil slope is located. The environmental data may include data such as temperature of the soil body, humidity, pH, and other data affecting corrosion or fatigue of the reinforcement material at each of the predetermined point locations. In some embodiments, the environmental data may be acquired by devices such as temperature sensors, humidity sensors, pH sensors, or the like.

In some embodiments, the processor may construct the degradation prediction model by training with a large count of training samples and labels corresponding to the training samples. The processor may perform the following training process to obtain the degradation prediction model. The training process includes obtaining a plurality of training samples with labels to form a training sample set, and executing a plurality of iterations based on the training sample set. At least one iteration includes: selecting one or more training samples from the training data set, inputting the one or more training samples into an initial degradation prediction model, obtaining model prediction outputs corresponding to the one or more training samples; substituting the model prediction outputs corresponding to the one or more training samples and the labels corresponding to the one or more training samples into a predefined loss function to determine a value of the loss function; iteratively updating model parameters in the initial degradation prediction model according to the value of the loss function; ending the iterations until an iteration end condition is satisfied, and obtaining the trained degradation prediction model. The iteratively updating of the model parameters of the degradation prediction model may be performed through a variety of manners, for example, iteratively updating based on a gradient descent method. The iteration end condition may include the loss function converging or a count of iterations reaching an iteration count threshold, etc.

In some embodiments, the training samples may include sample strain of sample reinforcement materials and sample environmental data from sample soil slopes. The labels are sample degradation degrees corresponding to the training samples.

In some embodiments, the training samples and the labels may be determined based on historical data, for example, the historical data includes a plurality of monitoring records from a historical target reinforced soil slope. The processor may determine a plurality of preferred degradation cases from the historical data and construct the training samples and the labels based on the plurality of preferred degradation cases.

The preferred degradation case refers to a monitoring record in which the degradation degree of the reinforcement material of the historical target reinforced soil slope meets a predetermined condition and whose monitoring data is complete. The monitoring record includes historical strain of the reinforcement material, historical environmental data, and historical degradation degree of the historical target reinforced soil slope. The monitoring data is complete refers to that it includes historical strain of the reinforcement material, historical environmental data, and historical degradation degree of the historical target reinforced soil slope during consecutive time periods.

In some embodiments, the predetermined condition may include that a difference between an estimated degradation degree and an actual degradation degree obtained through instrumentation measurements being within a predetermined tolerance range. The preset tolerance range may be determined based on empirical predetermining, such as ±10%.

The designed tensile strength per unit width of the reinforcement material T_{R} refers to the tensile strength per unit width of the reinforcement material which is capable of withstanding during the design phase of use. The unit for the designed tensile strength per unit width of the reinforcement material T_{R} may be kN/m.

In some embodiments, the processor may determine the designed tensile strength per unit width T_{R} of the reinforcement material through a first predetermined table based on a type, a specification, and a design safety factor of the reinforcement material. The first predetermined table may be determined by a predetermination including a correspondence between the type, the specification, and the design safety factor of the reinforcement material and the designed tensile strength per unit width T_{R} of the reinforcement material. The first predetermined table may be constructed based on the historical data.

In some embodiments, for each of the predetermined point locations in the target reinforced soil slope, the processor may also determine a designed tensile strength per unit width T_{R} of the reinforcement material at each of the predetermined point locations based on the degradation degree in the performance of the reinforcement material at each of the predetermined point locations, for example, via Equation (14):

$${T}_{R} = {T}_{R 0} \times ( 1 - D ) . \qquad ( 14 )$$

In Equation (14), D denotes the degradation degree in the performance of the reinforcement material at a certain predetermined point location in the target reinforced soil slope; and T_{R0} denotes an initial predetermined value of the designed tensile strength per unit width of the reinforcement material. T_{R0} may be determined based on a factory description of the reinforcement material, with T_{R0} of each of the predetermined point locations in the target reinforced soil slope is the same.

In some embodiments, after determining the designed tensile strength per unit width of the reinforcement material T_{R} according to Equation (14), since the designed tensile strength per unit width of the reinforcement material T_{R} may be used to reflect an extent to which the reinforcement material contributes to the resisting moment of the target reinforced soil slope, the processor may use the designed tensile strength per unit width of the reinforcement material T_{R} as an input to the stability factor calculation model, and redetermine the stability factor for each of the predetermined point locations via Equation (13).

In some embodiments of the present disclosure, the designed tensile strength per unit width of the reinforcement material T_{R} may be determined by the degradation degree in the performance of the reinforcement material, and the stability factor may be updated in real time based on a loss degree of the reinforcement material, which ensures the reliability of the analysis results for the target reinforced soil slope.

In some embodiments, the processor may also determine a plurality of critical sliding surfaces based on a plurality of predetermined point locations in the soil slope; for each critical sliding surface, determine a grouting parameter of the critical sliding surface based on the stability factor of each of the predetermined point locations on the critical sliding surface, structural characteristics of the soil body, and material characteristics of grouting slurry; and control an automatic grouting robot to inject grout into the soil slope based on the grouting parameter.

The critical sliding surface refers to a sliding surface where sliding may occur.

In some embodiments, the processor may compute an average stability factor of each sliding surface based on a plurality of predetermined sliding surfaces, and determine the sliding surface with the average stability factor below a predetermined safety threshold as the critical sliding surface.

The plurality of predetermined sliding surfaces may be a plurality of circular sliding surfaces disposed at equal spacing.

The average stability factor refers to an average of the stability factors of a plurality of predetermined point locations on the sliding surface, which is used to reflect the overall stability state of the sliding surface.

The predetermined safety threshold may be determined based on empirical predetermining.

The structural characteristics of the soil body refer to the mechanical and tectonic properties of the soil body within the critical sliding surface. In some embodiments, the structural characteristics of the soil body may include soil layer type, porosity, or the like. The soil layer type may include rubble soil, silty clay, sandy soil, or the like. The processor may determine the structural characteristics of the soil body based on a geological survey report obtained by pre-detection of a geological detector.

The material characteristics of the grouting slurry refer to properties of the slurry material used for grouting operations. In some embodiments, the material characteristics of the grouting slurry may include a slurry type, an initial setting time, a slurry viscosity, or the like. The slurry type may include one or a combination of a cement slurry, a chemical slurry, a water glass slurry, or a bentonite slurry. The processor may determine the material characteristics of the grouting slurry from a product technical data table of the slurry provided by a manufacturer.

The grouting parameter refers to a control parameter of a grouting process. In some embodiments, the grouting parameter may include at least one of a grouting hole location, a grout volume, and a grouting pressure.

The grouting hole location refers to a spatial placement location of a grouting inlet. In some embodiments, the grouting hole location may be an equally spaced array of dots on the critical sliding surface. The grouting hole location may also be represented as dots located on a three-dimensional surface of the critical sliding surface, such as the dots located on an upper edge, a center part, a lower edge of the critical sliding surface.

The grout volume refers to an actual volume of slurry injected at the grouting hole location. The grout volume can be used to reflect the need for reinforcement strength requirement at that location. In some embodiments, the grout volume may be inversely proportional to an average of the stability factors of a plurality of points around the grouting hole location, (i.e., the more unstable the grouting hole location is, the greater the grout volume is).

The grouting pressure refers to an injection pressure of the applied slurry at the grouting hole location. In some embodiments, the grouting pressure is typically proportional to the average of the stability factors of the plurality of points around the grouting hole location, (i.e., the more unstable the grouting hole location is, the lower the grouting pressure is) to ensure that the slurry can diffuse inside the target reinforced soil slope while not scouring the critical sliding surface.

In some embodiments, the processor may determine the grouting parameter for the critical sliding surface based on the stability factor of each of the predetermined point locations on the critical sliding surface, the structural characteristics of the soil body, and the material characteristics of the grouting slurry in a variety of ways, for example, by querying a second predetermined table. The second predetermined table may include a correspondence between the stability factor, the structural characteristics of the soil body, and the material characteristics of the grouting slurry of each of the predetermined point locations on the critical sliding surface, and the grouting parameters.

In some embodiments, the second predetermined table may be constructed based on historical grouting reinforcement records. The processor may collect a plurality of historical grouting reinforcement records and filter out historical grouting reinforcement records corresponding to the critical sliding surface with the average of the stability factor higher than a predetermined stability threshold after grouting reinforcement. The historical grouting reinforcement records may include the stability factor of each point on the critical sliding surface, structural characteristics of the soil body, the material characteristics of the grouting slurry, and actual grouting parameters selected in the historical grouting reinforcement records. The processor may fill in various data from the historical grouting reinforcement records into the second predetermined table to obtain the second predetermined table. Exemplary second predetermined table is as follows.

| | Soil | | | Initial | Slurry | Grouting | | Grouting |
|---|---|---|---|---|---|---|---|---|
| Serial | layer | | Slurry | setting | viscosity/ | hole | Grout | pressure/ |
| No. | type | Porosity | type | time/min | P · S | location | volume/L | MPa |
| 1 | Rubble | 0.32 | Bentonite- | 6 | 0.028 | Upper edge of | 130 | 0.60 |
| | soil | | cement | | | the critical | | |
| | | | composite | | | sliding surface | | |
| | | | slurry | | | | | |
| 2 | Silty | 0.48 | Cement- | 2 | 0.010 | Central part of | 90 | 0.25 |
| | clay | | water | | | the critical | | |
| | | | glass two- | | | sliding surface | | |
| | | | component | | | | | |
| | | | slurry | | | | | |
| 3 | Sandy | 0.40 | Cement | 8 | 0.018 | Lower edge | 110 | 0.40 |
| | soil | | slurry | | | of the critical | | |
| | | | | | | sliding surface | | |

The automatic grouting robot refers to a robot for automatic grouting. In some embodiments, the automatic grouting robot may be loaded with an automated drill rig and an automated grouting pump.

In some embodiments, the processor may drive the automatic grouting robot to perform drilling and grouting operations on the critical sliding surface in accordance with the grouting parameter to reinforce a structure of the critical sliding surface.

In some embodiments of the present disclosure, the second predetermined table is constructed based on the stability factor of the each point on the critical sliding surface, the structural characteristics of the soil body, and the material characteristics of the grouting slurry, and the grouting parameters are determined based on the second predetermined table, which is capable of quickly completing preliminary work of the drilling and grouting operations and at the same time ensure the accuracy of the drilling and grouting operations.

In some embodiments, in response to the presence of instability of the critical sliding surface, the processor may also control a concrete spraying robot to reinforce the critical sliding surface with concrete spraying based on a spraying parameter.

In some embodiments, when the average stability factor of the critical sliding surface is lower than a predetermined limit threshold, the processor may determine that the critical sliding surface is unstable. At this point, the critical sliding surface is not capable of supporting the automatic grouting robot to perform drilling and grouting operations on it.

The predetermined limit threshold may be determined based on a predetermination, and the predetermined limit threshold is lower than the predetermined safety threshold.

The spraying parameter refers to a parameter that is used to control the concrete spraying reinforcement operation. In some embodiments, the spraying parameter may include one or a combination of a spraying thickness, an interval time, and a spraying pressure.

The spraying thickness refers to the thickness of the reinforcement layer formed on the critical sliding surface. The spraying thickness may be inversely proportional to an average stability factor of an area being sprayed, and be directly proportional to the slope of the soil body of the area being sprayed, (i.e., the more unstable the area to be sprayed is or the steeper the slope is, the spraying thickness needs to be increased to enhance the effect of concrete support).

The interval time refers to a time interval between two adjacent spraying operations when spraying the area being sprayed. In some embodiments, the processor may predetermine the interval time based on the initial setting time to ensure the initial setting of the reinforcement material and prevent local accumulation or flowing. For example, the processor may multiply the value of the initial setting time by 90% to determine the interval time.

The spraying pressure refers to a working pressure at which the concrete is sprayed from a spray nozzle of the concrete spraying robot. In some embodiments, the spraying pressure may be directly proportional to the average stability factor of the area being sprayed, and inversely proportional to the slope of the soil body of the area being sprayed, to avoid disturbing damage to unconsolidated zones or steep slope sections caused by the concrete spraying reinforcement.

In some embodiments, the processor may control the concrete spraying robot to spray the entire area of the critical sliding surface using the predetermined spraying parameter. The predetermined spraying parameter may be determined based on empirical predetermining.

In some embodiments, the critical sliding surface may be divided into a plurality of sub-regions, and spraying is performed separately for each of the sub-regions with corresponding spraying parameter.

In some embodiments, each of the plurality of sub-regions includes a plurality of predetermined point locations, and each of the predetermined point locations may serve as a sampling point for the stability factor.

In some embodiments, the processor may determine a spraying parameter for each of the plurality of sub-regions by querying a third predetermined table based on a distribution of stability factors and a distribution of slopes of the plurality of sub-regions of the critical sliding surface. The distribution of the stability factors may include the distribution of the average stability factor of each sub-region, for example, the distribution of the stability factors may be expressed as {(sub-region A, the average stability factor a), (sub-region B, the average stability factor b), (sub-region C, the average stability factor c)}, where a, b, and c represent the average stability factors corresponding to sub-regions A, B, and C, respectively. The distribution of the slopes may include the distribution of slope of the soil body in each sub-region, for example, the distribution of the slopes may be expressed as {(sub-region A, the slope of the soil body a1), (sub-region B, the slope of the soil body b1), (sub-region C, the slope of the soil body c1)}, where a1, b1, and c1 represent the slopes of the soil body corresponding to sub-regions A, B, and C, respectively, and the slopes of the soil body may be a range of slopes for the soil body in the sub-region. The third predetermined table includes a correspondence between the distribution of the stability factors, the distribution of the slopes on the critical sliding surface, and the spraying parameter.

In some embodiments, the third predetermined table may be constructed based on historical spraying reinforcement records. The processor may collect the historical spraying reinforcement records and filter out the historical spraying reinforcement records corresponding to the critical sliding surface with the average stability factor higher than the predetermined stability threshold after spraying reinforcement. The historical spraying reinforcement records may include the distribution of the stability factors and the distribution of the slopes on the critical sliding surface, and actual spraying parameters selected in the historical spraying reinforcement records. The processor may fill in various data from the historical spraying reinforcement records into the third predetermined table to obtain the third predetermined table. The third predetermined table is set up in a format similar to the second predetermined table, and will not be repeated here.

The concrete spraying robot refers to a robot used to perform concrete spraying reinforcement operations. In some embodiments, the concrete spraying robot is configured to be loaded with a spraying device and a moving mechanism.

In some embodiments, the processor may control the concrete spraying robot to spray concrete material onto the critical sliding surface based on the spraying parameter for reinforcement purposes.

In some embodiments of the present disclosure, by determining the spraying parameter and utilizing the concrete spraying robot to perform the spraying operation on the critical sliding surface, the reinforcement operation can be implemented in a timely manner in accordance with the stability level of the critical sliding surface to ensure the stability of the critical sliding surface and to avoid an accident from occurring.

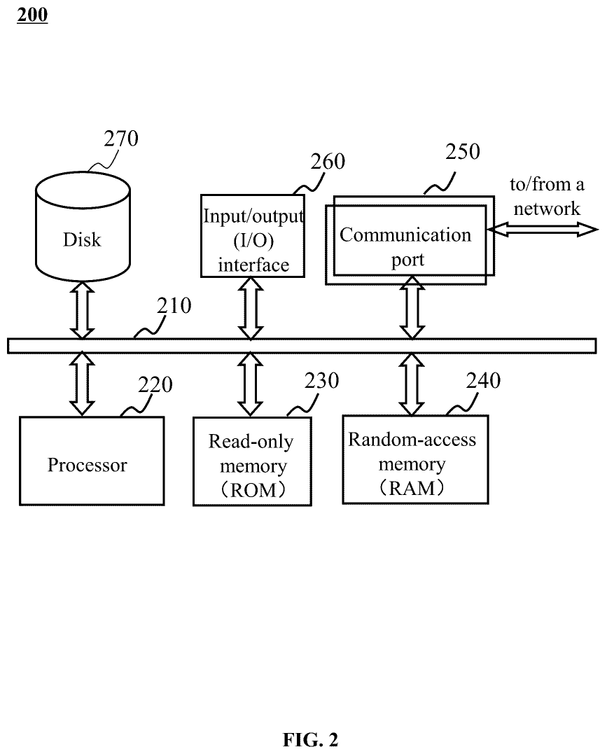

FIG. 2 is a schematic diagram illustrating exemplary hardware and software components of an exemplary computing device 200 according to some embodiments of the present disclosure. The computing device 200 may be configured to perform one or more of the functions of the each of modules of a stability analysis system for the reinforced soil slope described in embodiments of the present disclosure.

The computing device 200 may be a general-purpose computer or a special-purpose computer, both of which may be configured to implement the stability analysis system for the reinforced soil slope of the present specification. The computing device 200 may be configured to implement any of the components of the stability analysis system for the reinforced soil slope as described in the present of disclosure. For example, the processor may be implemented on the computing device 200 by its hardware, software program, firmware, or a combination thereof. For convenience, only one computer is shown in the FIG. 2, but the computer functions described herein relating to the stability analysis of reinforced soil slopes may be implemented in a distributed manner on a plurality of similar platforms to spread out processing loads.

For example, the computing device 200 may include a communication port 250 that is connected to and/or from a network to enable data communication. The computing device 200 may also include a processor 220 in the form of one or more processors for executing program instructions. Exemplary computer platforms may include an internal communication bus 210, different types of program memory and data memory (e.g., a disk 270, a read-only memory (ROM) 230, or a random-access memory (RAM) 240), and various data files that are processed and/or transmitted by the computer. Exemplary computing platforms also include program instructions executed by the processor 220 stored in the ROM 230, the RAM 240, and/or other forms of non-transitory storage media. The methods and/or processes of the present disclosure may be implemented as program instructions. The computing device 200 may also include an input/output (I/O) interface 260 that may support input/output between the computer and other components. The computing device 200 may also receive programming and data via network communication.

Merely by way of example, only one CPU and/or processor is exemplarily described in the computing device 200. However, it should be noted that the computing device 200 of the present disclosure may include a plurality of CPUs and/or processors, and thus operations and/or manners described in the present disclosure may also be implemented by the plurality of CPUs and/or processors, either jointly or independently. For example, if in the present disclosure, the CPU and/or processor of the computing device 200 performs operation A and operation B, it should be understood that the operation A and the operation B may also be performed jointly or independently by two different CPUs and/or processors in the computing device 200 (e.g., a first processor performs the operation A, a second processor performs the operation B, or the first processor and the second processor jointly perform the operation A and the operation B).

Aspects of the present disclosure may be performed entirely by a hardware, entirely by a software (including a firmware, a resident software, a microcode, etc.), or by a combination of the hardware and the software. All of the above hardware or software may be referred to as a “block,” “module,” “engine,” “unit,” “component,” or “system” etc. Additionally, aspects of the present disclosure may be manifested as a computer product disposed in one or more computer-readable mediums, the computer product includes computer-readable program code.

The computer storage medium may be any computer-readable medium that may be configured to communicate, disseminate, or transmit a program for use by being coupled to an instruction-executing system, device, or equipment. The program code residing on the computer storage medium may be disseminated via any suitable medium, including radio, cable, fiber optic cable, RF, or the like, or any combination thereof.

Computer program codes required for the operation of the various portions of the present disclosure may be written in any one or more programming languages. The program code may be run entirely on the computer of user, or as a stand-alone software package on the computer of the user, or partly on the computer of the user and partly on a remote computer, or be run entirely on a remote computer or a processing device. In the latter case, the remote computer may be connected to the computer of the user through any form of network, such as a local area network (LAN) or a wide area network (WAN), or connected to an external computer (e.g., via the Internet), or in a cloud computing environment, or used as a service such as software as a service (SaaS).

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for stability analysis of a reinforced soil slope considering a uniformly distributed frictional resistance between soil and a reinforcement material, comprising:
establishing a cross-sectional model for a target reinforced soil slope to be analyzed, including establishing computational relationships for the target reinforced soil slope including: a vertical load of a soil slope surface, a horizontal load of the soil slope surface, a unit weight per unit width of soil, a horizontal force of a slope body, a vertical shear force of the slope body, and a soil moment, wherein
the vertical load of the soil slope surface: p_{z}=(σ+τh′)Γₛ,
the horizontal load of the soil slope surface: pₓ=(τ−σh′) Γₛ,
the unit weight per unit width of soil:
$${w}_{γ} = {\int }_{{h}_{s}}^{h} γ dz ,$$
the horizontal force of the slope body:
$$E = {\int }_{{h}_{s}}^{h} {σ}_{x} dz ,$$
the vertical shear force of the slope body:
$$T = {\int }_{{h}_{s}}^{h} {τ}_{xz} dz ,$$
and
the soil moment:
$$M = {\int }_{{h}_{s}}^{h} {σ}_{x} ( h - z ) dz ,$$
where p_{z} denotes the vertical load of the soil slope surface, pₓ denotes the horizontal load of the soil slope surface, h denotes a sliding surface, h′ denotes a slope of the sliding surface, hₛ denotes the soil slope surface, o denotes a normal stress on the sliding surface, τ denotes a tangential shear stress on the sliding surface, w_{γ} denotes the unit weight per unit width of soil, γ denotes a unit weight of soil, E denotes the horizontal force of the slope body, T denotes the vertical shear force of the slope body, σₓ denotes a stress in an x-direction of the slope body, τ_{xz} denotes a vertical shear stress of the slope body, M denotes the soil moment, xz denotes a cross-section of the target reinforced soil slope, x denotes a horizontal direction of the cross-section of the target reinforced soil slope, z denotes a vertical direction of the cross-section of the target reinforced soil slope;
establishing a force equilibrium equation and a moment equilibrium equation for the target reinforced soil slope, wherein the force equilibrium equation includes Equation (1) and Equation (2):
$$σ {h}^{′} - τ = \frac{dE}{dx} - {p}_{x} - {τ}_{R} , \qquad ( 1 )$$
$$σ + τ {h}^{′} = {w}_{γ} + {σ}_{R} + {p}_{z} - \frac{dT}{dx} , \qquad ( 2 )$$
the moment equilibrium equation is Equation (3):
$${h}^{′} E - T = \frac{dM}{dx} - ( h - {h}_{s} ) {p}_{x} - {τ}_{R} ( h - {h}_{R} ) , \qquad ( 3 )$$
where in Equation (1), τ_{R} denotes a shear stress of the reinforcement material, and in Equation (2), σ_{R} denotes an axial stress of the reinforcement material, with
$${τ}_{R} = \frac{{dT}_{Rxy}}{dx} and {σ}_{R} = \frac{{dT}_{Rxy}}{dz} ,$$
and T_{Rxy} denotes a tension in a reinforcement layer;
establishing a moment equation for any point within the cross-section of the target reinforced soil slope based on the moment equilibrium equation, wherein the moment equation for any point (x_{R}, z_{R}) within the cross-section of the target reinforced soil slope is Equation (4):
$$\frac{d}{dx} [ ( h - {z}_{R} ) E - ( x - {x}_{R} ) T - M ] = ( h - {z}_{R} ) \frac{dE}{dx} - ( x - {x}_{R} ) \frac{dT}{dx} - ( h - {h}_{s} ) {p}_{x} - {τ}_{R} ( h - {h}_{R} ) , \qquad ( 4 )$$
establishing a soil yield function considering a stability function, wherein the soil yield function considering the stability function is Equation (5):
$$f = τ - \frac{1}{{F}_{s}} [ ( σ - u ) tan φ + c ] = 0 , \qquad ( 5 )$$
where in Equation (5), f denotes the soil yield function, Fₛ denotes a stability factor,
$${F}_{s} = \frac{{M}_{R}}{{M}_{0}} ,$$
wherein M_{R} denotes a sliding moment, M₀ denotes a resisting moment, u denotes a pore water pressure, φ denotes an internal friction angle of the soil, and c denotes a cohesion of the soil;
establishing a relationship between the force equilibrium equation, the moment equation for any point within the cross-section of the target reinforced soil slope, and the soil yield function based on Equation (6):
$$( 1 + {h}^{{′λ}_{F}} ) \frac{dE}{dx} + ( {h}^{′} - {λ}_{F} ) \frac{dT}{dx} = ( {h}^{′} - {λ}_{F} ) [ {w}_{γ} + {p}_{z} + {σ}_{R} ] - ( 1 + {h}^{′2} ) {c}_{F} + ( 1 + {h}^{{′λ}_{F}} ) ( {p}_{x} + {τ}_{R} ) , \qquad ( 6 )$$
where in Equation (6), λ_{F} denotes an internal friction angle parameter considering the stability factor,
$${λ}_{F} = \frac{tan φ}{{F}_{s}} ;$$
adding Equation (4) and Equation (6) multiplied by (h−z_{R}) to obtain Equation (7):
$$\frac{d}{dx} [ ( h - {z}_{R} ) E - ( x - {x}_{R} ) T - M ] = ( h - {z}_{R} ) \frac{dE}{dx} - ( x - {x}_{R} ) \frac{dT}{dx} - ( h - {h}_{s} ) {p}_{x} - {τ}_{R} ( h - {h}_{R} ) + ( {h}^{′} - {λ}_{F} ) ( h - {z}_{R} ) [ {w}_{γ} + {p}_{z} + {σ}_{R} ] - ( 1 + {h}^{′2} ) ( h - {z}_{R} ) {c}_{F} + ( 1 + {h}^{{′λ}_{F}} ) ( h - {z}_{R} ) ( {p}_{x} + {τ}_{R} ) - ( 1 + {h}^{{′λ}_{F}} ) ( h - {z}_{R} ) \frac{dE}{dx} - ( {h}^{′} - {λ}_{F} ) ( h - {z}_{R} ) \frac{dT}{dx} = - {h}^{′} {λ}_{F} ( h - {z}_{R} ) \frac{dE}{dx} - [ ( {h}^{′} - {λ}_{F} ) ( h - {z}_{R} ) - ( x - {x}_{R} ) ] \frac{dT}{dx} + ( {h}^{′} - {λ}_{F} ) ( h - {z}_{R} ) [ {w}_{γ} + {p}_{z} + {σ}_{r} ] - ( 1 + {h}^{′2} ) ( h - {z}_{R} ) {c}_{F} + ( 1 + {h}^{′} {λ}_{F} ) ( h - {z}_{R} ) ( {p}_{x} + {τ}_{R} ) - ( h - {h}_{s} ) {p}_{x} - {τ}_{R} ( h - {h}_{R} ) , \qquad ( 7 )$$
determining the resisting moment of the target reinforced soil slope, wherein when the sliding surface is circular, x−x_{R}=−h′(h−z_{R}), and Equation (7) becomes Equation (8):
$$\frac{d}{dx} [ ( h - {z}_{R} ) E - ( x - {x}_{R} ) T - M ] = - {h}^{′} {λ}_{F} ( h - {z}_{R} ) \frac{dE}{dx} + {λ}_{F} ( h - {z}_{R} ) \frac{dT}{dx} + ( {h}^{′} - {λ}_{F} ) ( h - {z}_{R} ) [ {w}_{γ} + {p}_{z} + {σ}_{R} ] - ( 1 + {h}^{′2} ) ( h - {z}_{R} ) {c}_{F} + ( 1 + {h}^{′} {λ}_{F} ) ( h - {z}_{R} ) ( {p}_{x} + {τ}_{R} ) - ( h - {h}_{s} ) {p}_{x} - {τ}_{R} ( h - {h}_{R} ) = ( {h}^{′} - {λ}_{F} ) ( h - {z}_{R} ) [ {w}_{γ} + {p}_{z} + {σ}_{R} ] - ( 1 + {h}^{′2} ) ( h - {z}_{R} ) {c}_{F} + ( 1 + {h}^{′} {λ}_{F} ) ( h - {z}_{R} ) ( {p}_{x} + {τ}_{R} ) - ( h - {h}_{s} ) {p}_{x} - {τ}_{R} ( h - {h}_{R} ) - {λ}_{F} ( h - {z}_{R} ) ( {h}^{′} \frac{dE}{dx} - \frac{dT}{dx} ) , \qquad ( 8 )$$
applying a same assumption as for an unreinforced soil slope, setting
$${h}^{′} \frac{dE}{dx} - \frac{dT}{dx} = 0 ,$$
and integrating Equation (7) to obtain Equation (9):
$${\int }_{{x}_{0}}^{{x}_{N}} [ ( {h}^{′} - {λ}_{F} ) ( h - {z}_{R} ) ( {w}_{γ} + {p}_{z} + {σ}_{R} ) - ( 1 + {h}^{′2} ) ( h - {z}_{R} ) {c}_{F} + ( 1 + {h}^{′} {λ}_{F} ) ( h - {z}_{R} ) ( {p}_{x} + {τ}_{R} ) - ( h - {h}_{s} ) {p}_{x} - {τ}_{R} ( h - {h}_{R} ) ] dx = 0$$
which is rearranged as:
$${\int }_{{x}_{0}}^{{x}_{N}} [ ( {x}_{R} - x ) ( {w}_{γ} + {p}_{z} + {σ}_{R} ) + ( {h}_{s} - {z}_{R} ) {p}_{x} + ( {h}_{R} - {z}_{R} ) {τ}_{R} - {λ}_{F} ( h - {z}_{R} ) ( {w}_{γ} + {p}_{z} + {σ}_{R} ) - ( 1 + {h}^{′2} ) ( h - {z}_{R} ) {c}_{F} - {λ}_{F} ( x - {x}_{R} ) {p}_{x} - {λ}_{F} ( x - {x}_{R} ) {τ}_{R} ] dx = 0 , \qquad ( 9 )$$
where in Equation (9), x₀ denotes an x-coordinate of an intersection point between the sliding surface and a slope top, and x_{N} denotes an x-coordinate of an intersection point between the sliding surface and a ground surface;
rearranging Equation (9) to obtain an Equation (10) for the resisting moment of the target reinforced soil slope:
$${M}_{0} = {\int }_{{x}_{0}}^{{x}_{N}} [ ( {x}_{R} - x ) ( {w}_{γ} + {p}_{z} ) + ( {h}_{s} - {z}_{R} ) {p}_{x} ] dx , \qquad ( 10 )$$
determining the sliding moment of the target reinforced soil slope;
in response to the reinforcement layer being horizontally placed and τ_{R} being a constant, obtaining an Equation from Equation (9) and Equation (10):
$${M}_{R} = {\int }_{{x}_{0}}^{{x}_{N}} [ λ ( h - {z}_{R} ) ( {w}_{γ} + {p}_{z} ) + ( 1 + {h}^{′2} ) ( h - {z}_{R} ) c + λ ( x - {x}_{R} ) {p}_{x} + λ ( - {x}_{R} ) {τ}_{R} - {F}_{s} ( {h}_{R} - {z}_{R} ) {τ}_{R} ] dx = {\int }_{{x}_{0}}^{{x}_{N}} [ λ ( h - {z}_{R} ) ( {w}_{γ} + {p}_{z} ) + ( 1 + {h}^{′2} ) ( h - {z}_{R} ) c + λ ( x - {x}_{R} ) {p}_{x} + λ ( x - {x}_{R} ) {τ}_{R} ] dx - {F}_{s} {τ}_{R} ( {h}_{R} - {z}_{R} ) ( {x}_{B} - {x}_{k} ) ,$$
which is rearranged as Equation (11):
$${M}_{R} = {\int }_{{x}_{0}}^{{x}_{N}} [ λ ( h - {z}_{R} ) ( {w}_{γ} + {p}_{z} ) + ( 1 + {h}^{′2} ) ( h - {z}_{R} ) c + λ ( x - {x}_{R} ) {p}_{x} + λ ( x - {x}_{R} ) {τ}_{R} ] dx - {F}_{s} {τ}_{R} ( {h}_{R} - {z}_{R} ) ( {x}_{B} - {x}_{k} ) , \qquad ( 11 )$$
setting −τ_{R}(x_{B}−xₖ)=T_{R}, T_{R} denotes a designed tensile strength per unit width of the reinforcement material, x_{B} denotes an x-coordinate of a right slope toe, and xₖ denotes an x-coordinate of an intersection point between the sliding surface and a soil slope bottom surface, yields:
$${M}_{R} = {\int }_{{x}_{0}}^{{x}_{N}} [ λ ( h - {z}_{R} ) ( {w}_{γ} + {p}_{z} ) + ( 1 + {h}^{′2} ) ( h - {z}_{R} ) c + λ ( x - {x}_{R} ) {p}_{x} + λ ( x - {x}_{R} ) {τ}_{R} ] dx + {F}_{s} {T}_{R} ( {h}_{R} - {z}_{R} )$$
and obtaining the sliding moment of the target reinforced soil slope expressed as Equation (12):
$${M}_{R} = {\int }_{{x}_{0}}^{{x}_{N}} [ λ ( h - {z}_{R} ) ( {w}_{γ} + {p}_{z} ) + ( 1 + {h}^{′2} ) ( h - {z}_{R} ) c + λ ( x - {x}_{R} ) {p}_{x} ] dx + {\int }_{{x}_{k}}^{{x}_{B}} [ λ ( x - {x}_{R} ) \frac{{T}_{R}}{{x}_{k} - {x}_{B}} ] dx + {F}_{s} {T}_{R} ( {h}_{R} - {z}_{R} ) , \qquad ( 12 )$$
where λ denotes a tangent of the internal friction angle of the soil, λ=tan φ;
establishing a stability factor calculation model for the target reinforced soil slope based on the resisting moment and the sliding moment using Equation (13):
$${F}_{s} = \frac{{M}_{R}}{{M}_{0}} = \frac{\begin{matrix}{\int }_{{x}_{0}}^{{x}_{N}} [ λ ( h - {z}_{R} ) ( {w}_{γ} + {p}_{z} ) + ( 1 + h {′}^{2} ) ( h - {z}_{R} ) c + \\ λ ( x - {x}_{R} ) {p}_{x} ] dx + {\int }_{{x}_{k}}^{{x}_{B}} [ λ ( x - {x}_{R} ) \frac{{T}_{R}}{{x}_{k} - {x}_{B}} ] dx + {F}_{s} {T}_{R} ( {h}_{R} - {z}_{R} )\end{matrix}}{{\int }_{{x}_{0}}^{{x}_{N}} [ ( {x}_{R} - x ) ( {w}_{γ} + {p}_{z} ) + ( {h}_{s} - {z}_{R} ) {p}_{x} ] dx} , \qquad ( 13 )$$
selecting a plurality of arbitrary points (x_{R}, z_{R}) within the cross-section of the target reinforced soil slope, and inputting information into the stability factor calculation model for the target reinforced soil slope, the information including:
the vertical load of the soil slope surface, the horizontal load of the soil slope surface, the unit weight of the soil, the internal friction angle of the soil, the cohesion of the soil, the designed tensile strength per unit width of the reinforcement material, the x-coordinate of the right slope toe, the x-coordinate of the intersection point between the sliding surface and the soil slope bottom surface, the x-coordinate of the intersection point between the sliding surface and the slope top, and the x-coordinate of the intersection point between the sliding surface and the ground surface,
calculating the stability factor for each point (x_{R}, z_{R}) according to the stability factor calculation model for the target reinforced soil slope, and
selecting a smallest stability factor as a final stability factor of the target reinforced soil slope to evaluate stability of the target reinforced soil slope.
